(19) United States
(12) Patent Application Publication
(10) Pub. No.: US 2019/0369768 A1
(43) Pub. Date: Dec. 5, 2019

(54) TOUCH DISPLAY PANEL

(71) Applicant: Wuhan China Star Optoelectronics Semiconductor Display Technology Co., Ltd., Wuhan (CN)

(72) Inventor: Caiqin CHEN, Wuhan, Hubei (CN)

(21) Appl. No.: 16/307,153

(22) PCT Filed: Aug. 7, 2018
(86) PCT No.: PCT/CN2018/099237

§ 371 Date: Dec. 5, 2018

(30) Foreign Application Priority Data
May 31, 2018 (CN) 201810549542.2

(51) Int. Cl. G06F 3/044

(52) U.S. Cl. CPC G06F 3/044

(57) ABSTRACT

The present disclosure provides a touch display panel including an array substrate; and metal layers, a light emitting layer, and a cathode layer sequentially disposed on the array substrate. A plurality of touch sense areas which are spaced apart are arranged in one of the metal layers. The cathode layer includes a plurality of cathode areas which are spaced apart. The cathode areas have a one to one relationship with the touch sense areas. Each of the cathode areas is vertically projected on a corresponding one of the touch sense areas.

### BACKGROUND

### Field

The present disclosure relates to a technological field of liquid crystal displays, and more particularly to a touch display panel.

### Background

Display technologies of organic light emitting diodes (OLEDs) are served as display technologies having high development potential. Each pixel in the display technologies of organic light emitting diodes has a self-luminous mode to replace a backlight mode. Accordingly, when compared with display technologies of liquid crystal displays, the display technologies of organic light emitting diodes have advantages that a view angle is significantly increased, power consumption is low, a contrast is high, a thickness of a screen is decreased, a response time is fast, and a light efficiency is high.

Touch screens have become a main type of an input. In portable electronic products including mobile phones, tablet computers, and electronic books, the touch screens have gradually replace an input from traditional mechanical keys. Finally, an input from touches without keys will be implemented. Integrating touch functions into display devices is an advanced technological trend.

The touch screens may be divided into plug-in touch screens, surface covering touch screens, and in-cell touch screens. In the plug-in touch screens, touch screens and liquid crystal display screens are manufactured respectively, and then liquid crystal display screens having a touch function are manufactured by adhering the touch screens and the liquid crystal display screens. The plug-in touch screens have disadvantages that a manufacturing cost is high, a light transmittance is low, and a module thickness is thick. In the in-cell touch screens, touch electrodes are embedded inside the liquid crystal display screens. As such, a total module thickness can be decreased, and a manufacturing cost of the touch screens can be reduced significantly. Therefore, the in-cell touch screens are favored by large panel manufacturers.

However, in the prior art, cathode layers are whole metal layers disposed in OLED displays, and thus touch sense circuits cannot be embedded in the OLED displays.

Consequently, defects exist in the prior art and urgently need to be improved.

### SUMMARY OF THE DISCLOSURE

An objective of embodiments of the present disclosure is to provide a touch display panel having a beneficial effect that a touch sense circuit can be embedded in the touch display panel to reduce a thickness of the touch display panel.

The present disclosure provides a touch display panel including an array substrate; and metal layers, a light emitting layer, and a cathode layer sequentially disposed on the array substrate. A plurality of touch sense areas which are spaced apart are arranged in one of the metal layers. The cathode layer includes a plurality of cathode areas which are spaced apart. The cathode areas have a one to one relationship with the touch sense areas. Each of the cathode areas is vertically projected on a corresponding one of the touch sense areas. The touch sense areas are self-capacitance touch sense areas. Each of the touch sense areas is electrically connected to a touch drive chip via an independent second signal line. The touch sense areas include a plurality of transmitting touch sense areas and a plurality of receiving touch sense areas. The transmitting touch sense areas are distributed in a rectangular array. The receiving touch sense areas are distributed in a rectangular array. The transmitting touch sense areas and the receiving touch sense areas are distributed interlacedly in a column direction.

In the touch display panel of the present disclosure, a plurality of first signal lines which are interlaced in a vertical direction and a horizontal direction and electrically connected to each other are formed in each of the touch sense areas.

In the touch display panel of the present disclosure, the first signal lines are data signal lines or reset signal lines, and the second signal lines are data signal lines or reset signal lines.

In the touch display panel of the present disclosure, the touch sense areas have a circular shape, a rectangular shape, or a prismatic shape, and two ends of each of the first signal lines in each of the touch sense areas are respectively extended to edges of the each of the touch sense areas.

In the touch display panel of the present disclosure, the touch sense areas are distributed in a rectangular array.

In the touch display panel of the present disclosure, two adjacent ones of the receiving touch sense areas in the same row are electrically insulated, two adjacent ones of the transmitting touch sense areas in the same row are electrically connected, two adjacent ones of the receiving touch sense areas in the same column are electrically connected via a jump wire, the transmitting touch sense areas in the same row are electrically connected to the touch transmitting chip via the second signal line, and the receiving touch sense areas in the same column are electrically connected to a touch receiving chip via a signal line.

In the touch display panel of the present disclosure, the first signal lines are data signal lines or reset signal lines, and the second signal lines are data signal lines or reset signal lines.

The present disclosure further provides a touch display panel including an array substrate; and metal layers, a light emitting layer, and a cathode layer sequentially disposed on the array substrate. A plurality of touch sense areas which are spaced apart are arranged in one of the metal layers. The cathode layer includes a plurality of cathode areas which are spaced apart. The cathode areas have a one to one relationship with the touch sense areas. Each of the cathode areas is vertically projected on a corresponding one of the touch sense areas.

In the touch display panel of the present disclosure, the touch sense areas are self-capacitance touch sense areas, and each of the touch sense areas is electrically connected to a touch drive chip via an independent second signal line.

In the touch display panel of the present disclosure, a plurality of first signal lines which are interlaced in a vertical direction and a horizontal direction and electrically connected to each other are formed in each of the touch sense areas.

In the touch display panel of the present disclosure, the first signal lines are data signal lines or reset signal lines, and the second signal lines are data signal lines or reset signal lines.

In the touch display panel of the present disclosure, the touch sense areas have a circular shape, a rectangular shape, or a prismatic shape, and two ends of each of the first signal lines in each of the touch sense areas are respectively extended to edges of the each of the touch sense areas.

In the touch display panel of the present disclosure, the touch sense areas are distributed in a rectangular array.

In the touch display panel of the present disclosure, the touch sense areas include a plurality of transmitting touch sense areas and a plurality of receiving touch sense areas. The transmitting touch sense areas are distributed in a rectangular array. The receiving touch sense areas are distributed in a rectangular array. The transmitting touch sense areas and the receiving touch sense areas are distributed interlacedly in a column direction.

In the touch display panel of the present disclosure, two adjacent ones of the receiving touch sense areas in the same row are electrically insulated. Two adjacent ones of the transmitting touch sense areas in the same row are electrically connected. Two adjacent ones of the receiving touch sense areas in the same column are electrically connected via a jump wire. The transmitting touch sense areas in the same row are electrically connected to the touch transmitting chip via the second signal line. The receiving touch sense areas in the same column are electrically connected to a touch receiving chip via a signal line.

In the touch display panel of the present disclosure, the first signal lines are data signal lines or reset signal lines, and the second signal lines are data signal lines or reset signal lines.

It can be understood from the above that in the present disclosure, the touch sense structures are disposed inside the touch display panel, and the touch sense structures are exposed by patterning the cathode layer. Accordingly, an in-cell touch sense manner can be implemented, and a thickness of the touch sense panel can be reduced.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show only some embodiments of the present disclosure, and those skilled in the art may still derive other drawings from these accompanying drawings without creative efforts.

FIG. 1 illustrates a touch display panel in accordance with an embodiment of the present disclosure.

FIG. 2 illustrates a topology structural diagram of a mutual capacitance of the touch display panel in accordance with an embodiment of the present disclosure.

FIG. 3 illustrates a structural diagram of a cathode layer of the touch display panel in FIG. 2 in accordance with an embodiment of the present disclosure.

FIG. 4 illustrates a topology structural diagram of a self-capacitance of the touch display panel in accordance with an embodiment of the present disclosure.

FIG. 5 illustrates a structural diagram of a cathode layer of the touch display panel in FIG. 4 in accordance with an embodiment of the present disclosure.

FIG. 6 illustrates a display circuit of the touch display panel in accordance with an embodiment of the present disclosure.

FIG. 7 illustrates a drive timing diagram when touch sense areas on the touch display panel of the present disclosure are mutual capacitance touch sense areas.

FIG. 8 illustrates a drive timing diagram when the touch sense areas on the touch display panel of the present disclosure are self-capacitance touch sense areas.

### DETAILED DESCRIPTION OF THE PREFERRED EMBODIMENTS

Hereinafter, exemplary embodiments of the present disclosure will be described with reference to the accompanying drawings. The same or similar elements or the elements with the same or similar functions will be designated by the same or similar reference numerals throughout the following description and drawings. The following embodiments described with the accompanying drawings are merely exemplary to explain the present disclosure and not to be construed as limiting the present disclosure.

In the description of the present disclosure, it should be understood that orientations or position relationships indicated by the terms “center”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, “clockwise”, and “counter-clockwise” are based on orientations or position relationships illustrated in the drawings. The terms are used to facilitate and simplify the description of the present disclosure, rather than indicate or imply that the devices or elements referred to herein is required to have specific orientations or be constructed or operates in the specific orientations. Accordingly, the terms should not be construed as limiting the present disclosure. Furthermore, the terms “first” and “second” are for descriptive purposes only and should not be construed as indicating or implying relative importance or implying the number of technical features. As such, the features defined by the term “first” and “second” may include one or more of the features explicitly or implicitly. In the description of the present disclosure, the term “more” refers two or more than two, unless otherwise specifically defined.

In the description of the present disclosure, it should be noted that unless otherwise clearly defined and limited, the terms “mounted”, “connected/coupled”, and “connection” should be interoperated broadly. For example, the terms may refer to a fixed connection, a detachable connection, or an integral connection; the terms may also refer to a mechanical connection, an electrical connection, or communication with each other; the terms may further refer to a direct connection, an indirect connection through an intermediary, or an interconnection between two elements or interactive relationship between two elements. Those skilled in the art can understand the specific meanings of the above-mentioned terms in the present disclosure according to circumstances.

In the present disclosure, it should be noted that unless otherwise clearly defined and limited, a first feature “on” or “under” a second feature may mean that the first feature directly contacts the second feature, or that the first feature contacts the second feature via an additional feature there between instead of directly contacting the second feature. Moreover, the first feature “on”, “above”, and “over” the second feature may mean that the first feature is right over or obliquely upward over the second feature or mean that the first feature has a horizontal height higher than that of the second feature. The first feature “under”, “below”, and “beneath” the second feature may mean that the first feature is right beneath or obliquely downward beneath the second feature or mean that that horizontal height of the first feature is lower than that of the second feature.

The following description provides various embodiments or examples for implementing various structures of the present disclosure. To simplify the description of the present disclosure, parts and settings of specific examples are described as follows. Certainly, they are only illustrative, and are not intended to limit the present disclosure. Further, reference numerals and reference letters may be repeated in different examples. This repetition is for purposes of simplicity and clarity and does not indicate a relationship of the various embodiments and/or the settings. Furthermore, the present disclosure provides specific examples of various processes and materials, however, applications of other processes and/or other materials may be appreciated those skilled in the art.

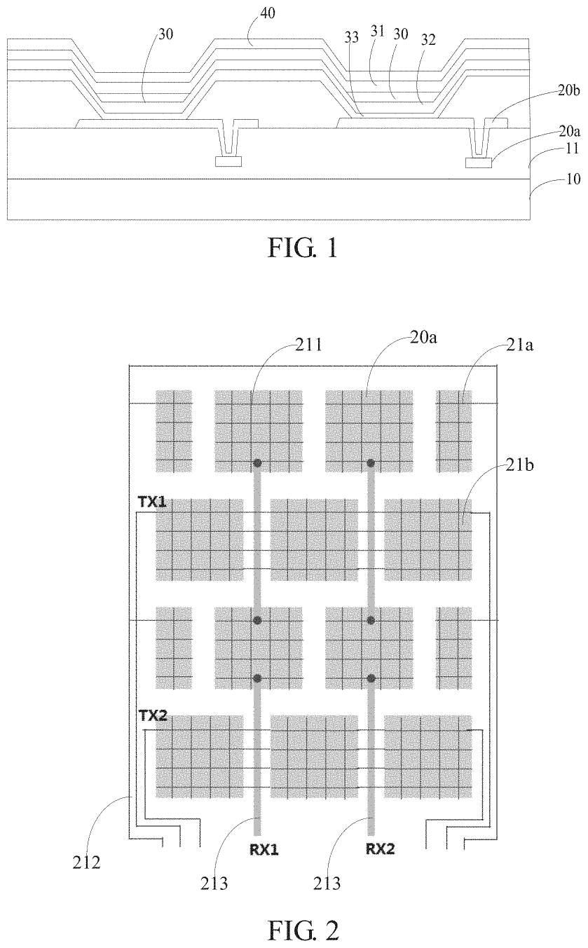

Please refer to FIG. 1. FIG. 1 illustrates a touch display panel in accordance with an embodiment of the present disclosure. The touch display panel includes an array substrate 10 and includes metal layers 20a and 20b, a light emitting layer 30, and a cathode layer 40 which are sequentially disposed on the array substrate 10, and a protective layer 50 positioned on the cathode layer 40. Certainly, it can be understood that the touch display panel is served as an OLED display panel, and thus a structure for implementing a basic function is essential, for example, an anode layer. The anode layer is not a focus of the present disclosure and not described in detail. A hole transport layer 32 and a hole injection layer 33 are disposed under the light emitting layer 30. An electron transport layer 31 is further disposed between the light emitting layer 30 and the cathode layer 40.

A plurality of touch sense areas 21 which are spaced apart are arranged in one of the metal layers 20a and 20b. The cathode layer 30 includes a plurality of cathode areas which are spaced apart. The cathode areas have a one to one relationship with the touch sense areas 21. Each of the cathode areas is vertically projected on a corresponding one of the touch sense areas 21. The touch sense areas 21 form touch sense structures. The touch sense structures are configured to constitute a self-capacitance structure or a mutual capacitance structure for detecting a position pressed on the touch display panel by a finger.

Please refer to FIG. 2. The touch sense areas 21 are mutual capacitance touch sense areas in some embodiments. Correspondingly, the touch sense structures are mutual capacitance touch sense structures. The touch sense areas 21 include a plurality of transmitting touch sense areas 21b and a plurality of receiving touch sense areas 21a. The transmitting touch sense areas 21b are distributed in a rectangular array. The receiving touch sense areas 21a are distributed in a rectangular array. The transmitting touch sense areas 21b and the receiving touch sense areas 21a are distributed interlacedly in a column direction. That is, one row of the transmitting touch sense areas 21b and one row of the receiving touch sense areas 21a are distributed alternately, and the transmitting touch sense areas 21b and the receiving touch sense areas 21a are interlaced.

In detail, each of the touch sense structures are formed by a plurality of first signal lines which are interlaced in a vertical direction and a horizontal direction and electrically connected to each other. That is, a plurality of first signal lines 211 which are interlaced in a vertical direction and a horizontal direction and electrically connected to each other are formed in each of the touch sense areas 21. Two ends of each of the first signal lines 211 in each of the touch sense areas 21 are respectively extended to edges of the each of the touch sense areas 21. Moreover, two adjacent ones of the receiving touch sense areas 21a in the same row are electrically insulated. Two adjacent ones of the transmitting touch sense areas 21b in the same row are electrically connected. Two adjacent ones of the receiving touch sense areas 21a in the same column are electrically connected via a metal jump wire 213. The transmitting touch sense areas 21b in the same row are electrically connected to a touch transmitting chip via a second signal line 212. The receiving touch sense areas 21a in the same column are electrically connected to a pin of a touch receiving chip via a signal line. An operating principle of the mutual capacitance structure is described as follows. For example, TX is arranged in a horizontal direction, and RX is arranged in a vertical direction. In a touch sense interval, TX is provided with a timing signal having a high frequency to drive one row of the transmitting touch sense areas 21b. RX receives a signal which is generated after the timing signal having the high frequency passes a capacitance (a sense capacitance formed between TX and RX). When a touch is performed by a finger, the finger changes the capacitance between TX and RX, thereby changing the signal in one interval. A chip can perform a logical operation to analyze a position of the touch of the finger.

It can be understood that the metal layers 20a and 20b may be metal layers which source electrodes, drain electrodes, and gate electrodes are located in the array substrate 10 or may be metal layers between one of the source electrodes and the drain electrodes and the gate electrodes. The first signal lines 211 are multiplexing function lines. In one aspect, the first signal lines 211 are served as data signal lines (i.e., Vdd lines) of the touch display panel. In another aspect, the first signal lines 211 form the touch sense structures of the touch sense areas. Alternatively, the first signal lines 211 are multiplexing function lines. In one aspect, the first signal lines 211 are served as reset signal lines (i.e., Vi lines) of the touch display panel. In another aspect, the first signal lines 211 form the touch sense structures of the touch sense areas. The second signal lines 212 may also be multiplexing function lines and may be Vdd lines or Vi lines.

Jump wires in other layers are utilized as jump wires from the receiving touch sense areas 21a to the transmitting touch sense areas 21b, so as to avoid that a short circuit occurs between trace lines and other touch sense structures of the touch sense areas. For example, Vdd lines are utilized in an SD metal layer. Jump wires in a horizontal direction are utilized in a GE1 metal layer, a GE2 metal layer, or an anode layer. Signals for TX signal lines may be provided by a chip or a GOA drive circuit.

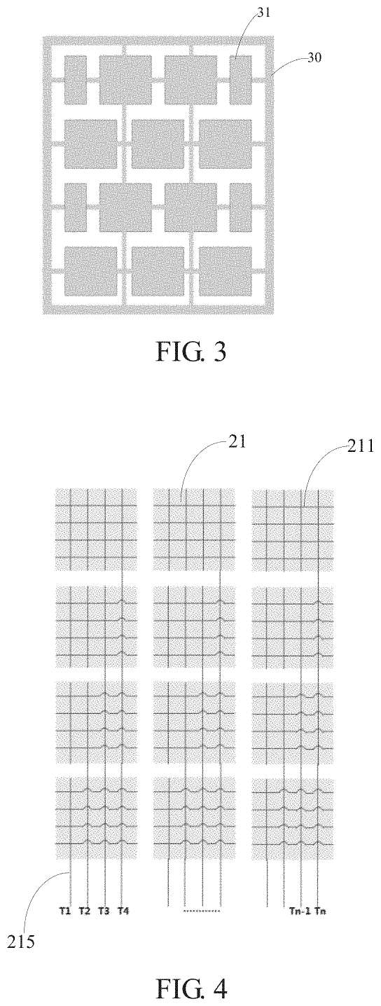

Please refer to FIG. 3. The touch sense areas 21 have a circular shape, a rectangular shape, or a prismatic shape. Correspondingly, the cathode areas 31 also have a circular shape, a rectangular shape, or a prismatic shape, but an area of each of the cathode areas 31 is smaller than an area of a corresponding one of the touch sense areas 21. A process of forming the cathode areas 31 is described as follows. A metal layer is formed first. Then, the metal layer is patterned (exposed, developed, and etched) to form the cathode areas 31 which are spaced apart.

Please refer to FIG. 4. The touch sense areas 21 are self-capacitance touch sense areas in some embodiments. Correspondingly, the touch sense structures are self-capacitance touch sense structures. Each of the touch sense areas 21 is electrically connected to a touch drive chip via an independent second signal line 215.

A plurality of first signal lines 211 which are interlaced in a vertical direction and a horizontal direction and electrically connected to each other are formed in each of the touch sense areas 21. The first signal lines 211 which are interlaced in the vertical direction and the horizontal direction form a touch sense structure. Two ends of each of the first signal lines 211 in each of the touch sense areas 21 are respectively extended to edges of the each of the touch sense areas 21. The touch sense areas 21 are distributed in a rectangular array and uniformly spaced apart. In a touch sense interval, a trace line provides a signal having a high frequency to drive one of the touch sense structures. The signal having the high frequency is provided for the one of the touch sense structures. A drive signal at a low level is inputted to adjacent touch sense structures sequentially. Accordingly, a capacitance between the driven touch sense structure and the adjacent touch sense structures is formed. The trace line receives a feedback signal of the driven touch sense structure. A chip can perform a logical operation to analyze a position of a touch of a finger.

In the present embodiment, the first signal lines 211 are multiplexing function lines. In one aspect, the first signal lines 211 are served as data signal lines (i.e., Vdd lines) of the touch display panel. In another aspect, the first signal lines 211 form the touch sense structures of the touch sense areas. Alternatively, the first signal lines 211 are multiplexing function lines. In one aspect, the first signal lines 211 are served as reset signal lines (i.e., Vi lines) of the touch display panel. In another aspect, the first signal lines 211 form the touch sense structures of the touch sense areas. The second signal lines 215 may also be multiplexing function lines and may be Vdd lines or Vi lines.

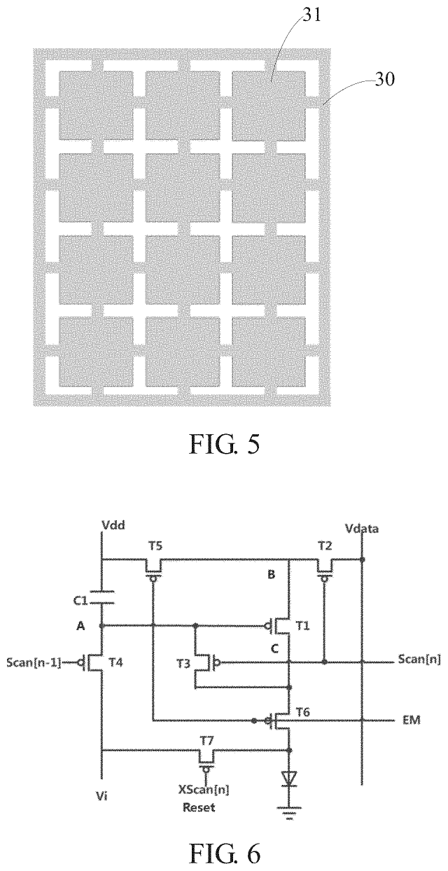

Please refer to FIG. 5. The touch sense areas 21 have a circular shape, a rectangular shape, or a prismatic shape. Correspondingly, the cathode areas 31 also have a circular shape, a rectangular shape, or a prismatic shape, but an area of each of the cathode areas 31 is smaller than an area of a corresponding one of the touch sense areas 21. A process of forming the cathode areas 31 is described as follows. A metal layer is formed first. Then, the metal layer is patterned (exposed, developed, and etched) to form the cathode areas 31 which are spaced apart. A distribution of the cathode areas 31 corresponds to a distribution of the touch sense areas 21. The jump wires for the trace lines cross the touch sense structures excluding the touch sense structure itself and need to use the jump wires in other metal layers, so as to avoid that a short circuit occurs between trace lines and other touch sense structures.

Please refer to FIG. 6. FIG. 6 illustrates a display circuit of the touch display panel in accordance with an embodiment of the present disclosure. The display circuit includes a typical 7T1C (including seven TFTs and one capacitor) drive circuit. In other embodiments, the display circuit may be another typical drive circuit, for example, a 6T1C circuit and a 7T2C circuit. The present embodiment illustrates how the signal line Vdd or the signal line Vi is multiplexed.

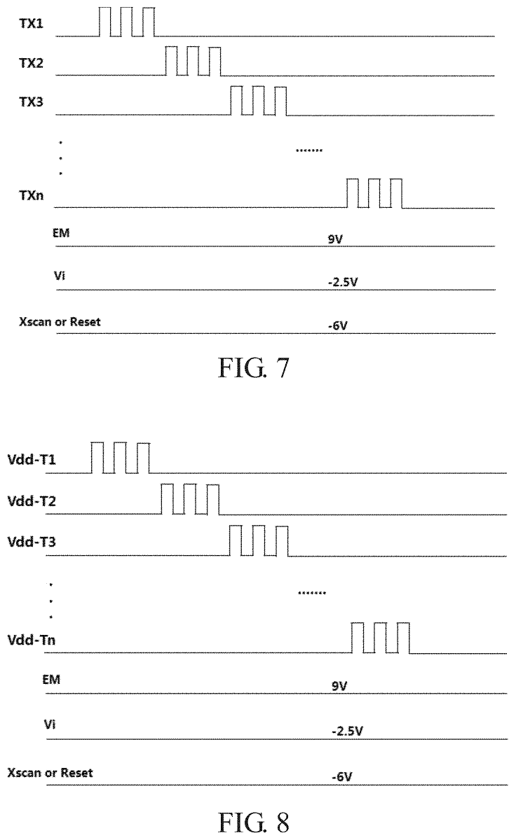

Please refer to FIG. 7. FIG. 7 illustrates a drive timing diagram when the touch sense areas on the touch display panel of the present disclosure are mutual capacitance touch sense areas. Taking PMOS devices for example. In an operating stage, a pixel drive signal XScan or a pixel drive signal Reset from n=1, 2, . . . , n is inputted by a signal at a low level. As such, an anode layer of the touch display panel is inputted by the signal at the low level. OLEDs are turned off. Scan signals from n=1, 2, . . . , n are provide with a high level. Transistors T1, T2, T3, and T4 in all of pixels are turned off. An EM signal from n=1, 2, . . . , n is provide with a high level. Transistors T5 and T6 in all of the pixels are turned off. Vdd line is divided into TX (is inputted by a signal having a high frequency), RX (receives a signal and is connected to a touch sense chip), and Dummy (is connected to the touch sense chip and inputted by a signal Vss or another signal having a low level). The signals of the cathode areas remain the same as those in a display stage. In the display stage, TX, RX, and Dummy are inputted by a signal having 4.5V. A timing of the scan signals, a timing of XScan, and a timing of EM can be pulled up or pulled down by disposing a reset unit in GOA, thereby pulling up or pulling down output signals simultaneously.

Please refer to FIG. 8. FIG. 8 illustrates a drive timing diagram when the touch sense areas on the touch display panel of the present disclosure are self-capacitance touch sense areas. Taking PMOS devices for example. In an operating stage, a pixel drive signal XScan or a pixel drive signal Reset from n=1, 2, . . . , n is inputted by a signal at a low level. As such, an anode layer of the touch display panel is inputted by the signal at the low level. OLEDs are turned off. Scan signals from n=1, 2, . . . , n are provide with a high level. Transistors T1, T2, T3, and T4 in all of pixels are turned off. An EM signal from n=1, 2, . . . , n is provide with a high level. Transistors T5 and T6 in all of the pixels are turned off. Vdd line is provided with a signal having a high frequency. The signals of the cathode areas remain the same as those in a display stage. A timing of the scan signals, a timing of XScan, and a timing of EM can be pulled up or pulled down by disposing a reset unit in GOA, thereby pulling up or pulling down output signals simultaneously.

It can be understood from the above that in the present disclosure, the touch sense structures are disposed inside the touch display panel, and the touch sense structures are exposed by patterning the cathode layer. Accordingly, an in-cell touch sense manner can be implemented, and a thickness of the touch sense panel can be reduced.

In summary, although the present disclosure has been provided in the preferred embodiments described above, the foregoing preferred embodiments are not intended to limit the present disclosure. Those skilled in the art, without departing from the spirit and scope of the present disclosure, may make modifications and variations, so the scope of the protection of the present disclosure is defined by the claims.

What is claimed is:

1. A touch display panel, comprising:
an array substrate; and
metal layers, a light emitting layer, and a cathode layer sequentially disposed on the array substrate,
wherein a plurality of touch sense areas which are spaced apart are arranged in one of the metal layers;
the cathode layer comprises a plurality of cathode areas which are spaced apart, the cathode areas have a one to one relationship with the touch sense areas, and each of the cathode areas is vertically projected on a corresponding one of the touch sense areas;
the touch sense areas are self-capacitance touch sense areas, and each of the touch sense areas is electrically connected to a touch drive chip via an independent second signal line;
the touch sense areas comprise a plurality of transmitting touch sense areas and a plurality of receiving touch sense areas;
the transmitting touch sense areas are distributed in a rectangular array;
the receiving touch sense areas are distributed in a rectangular array; and
the transmitting touch sense areas and the receiving touch sense areas are distributed interlacedly in a column direction.

2. The touch display panel of claim 1, wherein a plurality of first signal lines which are interlaced in a vertical direction and a horizontal direction and electrically connected to each other are formed in each of the touch sense areas.

3. The touch display panel of claim 2, wherein the first signal lines are data signal lines or reset signal lines, and the second signal lines are data signal lines or reset signal lines.

4. The touch display panel of claim 3, wherein the touch sense areas have a circular shape, a rectangular shape, or a prismatic shape, and two ends of each of the first signal lines in each of the touch sense areas are respectively extended to edges of the each of the touch sense areas.

5. The touch display panel of claim 3, wherein the touch sense areas are distributed in a rectangular array.

6. The touch display panel of claim 1, wherein two adjacent ones of the receiving touch sense areas in the same row are electrically insulated, two adjacent ones of the transmitting touch sense areas in the same row are electrically connected, two adjacent ones of the receiving touch sense areas in the same column are electrically connected via a jump wire, the transmitting touch sense areas in the same row are electrically connected to the touch transmitting chip via the second signal line, and the receiving touch sense areas in the same column are electrically connected to a touch receiving chip via a signal line.

7. The touch display panel of claim 6, wherein the first signal lines are data signal lines or reset signal lines, and the second signal lines are data signal lines or reset signal lines.

8. A touch display panel, comprising:
an array substrate; and
metal layers, a light emitting layer, and a cathode layer sequentially disposed on the array substrate,
wherein a plurality of touch sense areas which are spaced apart are arranged in one of the metal layers;
the cathode layer comprises a plurality of cathode areas which are spaced apart, the cathode areas have a one to one relationship with the touch sense areas, and each of the cathode areas is vertically projected on a corresponding one of the touch sense areas.

9. The touch display panel of claim 8, wherein the touch sense areas are self-capacitance touch sense areas, and each of the touch sense areas is electrically connected to a touch drive chip via an independent second signal line.

10. The touch display panel of claim 9, wherein a plurality of first signal lines which are interlaced in a vertical direction and a horizontal direction and electrically connected to each other are formed in each of the touch sense areas.

11. The touch display panel of claim 10, wherein the first signal lines are data signal lines or reset signal lines, and the second signal lines are data signal lines or reset signal lines.

12. The touch display panel of claim 11, wherein the touch sense areas have a circular shape, a rectangular shape, or a prismatic shape, and two ends of each of the first signal lines in each of the touch sense areas are respectively extended to edges of the each of the touch sense areas.

13. The touch display panel of claim 11, wherein the touch sense areas are distributed in a rectangular array.

14. The touch display panel of claim 8, wherein the touch sense areas comprise a plurality of transmitting touch sense areas and a plurality of receiving touch sense areas;
the transmitting touch sense areas are distributed in a rectangular array;
the receiving touch sense areas are distributed in a rectangular array; and
the transmitting touch sense areas and the receiving touch sense areas are distributed interlacedly in a column direction.

15. The touch display panel of claim 8, wherein two adjacent ones of the receiving touch sense areas in the same row are electrically insulated, two adjacent ones of the transmitting touch sense areas in the same row are electrically connected, two adjacent ones of the receiving touch sense areas in the same column are electrically connected via a jump wire, the transmitting touch sense areas in the same row are electrically connected to the touch transmitting chip via the second signal line, and the receiving touch sense areas in the same column are electrically connected to a touch receiving chip via a signal line.

16. The touch display panel of claim 15, wherein the first signal lines are data signal lines or reset signal lines, and the second signal lines are data signal lines or reset signal lines.
